(19) United States
(12) Patent Application Publication
(10) Pub. No.: US 2002/0119314 A1
(43) Pub. Date: Aug. 29, 2002

(54) Colorized rubber and method of making same

(76) Inventor: Gerald P. Coffey, Chagrin Falls, OH (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 10/027,718

(22) Filed: Dec. 20, 2001

Related U.S. Application Data
(60) Provisional application No. 60/257,231, filed on Dec. 21, 2000.

(51) Int. Cl. B32B 5/16

(52) U.S. Cl. 428/407; 428/403

(57) ABSTRACT

The present invention is directed to colorized rubber and methods of coloring the same, particularly vulcanized rubber, and rubber particles. The present invention is more particularly directed to colorized vulcanized rubber particles having improved color durability. The present invention is also directed to utilization of the colorized rubber as synthetic mulch. In the compositions and methods of the present invention, it is preferable that aqueous organic or inorganic pigment dispersions are mixed with vulcanized rubber particles to color coat the rubber particles. Preferably an emulsion polymer is added to the color coated particles to encapsulate the particles. The resulting colored vulcanized rubber particles exhibit improved color stability and color abrasion resistance.

### CROSS-REFERENCE WITH RELATED APPLICATIONS

This application claims the benefit of U.S. Provisional Patent Application No. 60/257,231, filed Dec. 21, 2000.

### BACKGROUND OF THE INVENTION

Ongoing efforts have been made to improve the quality of the environment by removing scrap tires from landfills and converting them to useful products. Legislative initiatives have addressed the removal of scrap tires from the environment and the conversion of scrap tires into useful products. A common theme in scrap tire conversion is grinding the tires to produce various sized and shaped rubber particles which can then be put to a productive use. Typical uses of scrap tire grinds include supplemental feedstocks to enhance the BTU fuel value of selected energy sources, backfill materials to facilitate drainage around foundations, additives to enhance the surface characteristics of various materials used in road construction, soil amendments to provide solutions to soil compaction, building products such as aerosol based roofing and weatherproofing systems, and recreational safety surfaces.

Scrap tire grinds are also commonly used for products such as landscaping mulch and protective surfaces for playgrounds. In fact, the Consumer Product Safety Commission has given its highest rating to rubber particles as the preferred choice of material to be used on playground surfaces to protect children from falls. The protection offered by rubber particles against falls has been proven to be far superior to any other material commonly used for this purpose in playgrounds, including wood chips, bark mulch, sand, and pea gravel.

Coloring of vulcanized rubber particles and especially the attendant color durability are technically challenging issues. Thus, vulcanized rubber products for landscaping mulch and protective safety surfaces for playgrounds have generally been limited to uncolored scrap tire grinds. However, efforts have been made to address the demand for colored surfaces. For example, the use of water soluble colorants compounded with a modified acrylic copolymer and rheological additives as well as the formation of artificial mulch chips from thermoplastic materials have been described as efforts to address this demand.

U.S. Pat. Nos. 5,105,577, 5,396,751, 5,543,172, 5,910,514, and 6,036,998 describe various processes and products relating to colorized rubber, mulch chips and the like.

Methods known in the art for coloring vulcanized rubber particles are notably inadequate to satisfy requirements for applications such as playground safety surfaces and landscape mulch. This is because important performance characteristics relating to color durability and color abrasion resistance are marginal to poor. Additionally, some vulcanized rubber coloring systems contain volatile organic compounds (VOCs) that can participate in atmospheric photochemical reactions and can therefore be unfriendly and polluting to the environment. It therefore can be appreciated that the utility of scrap vulcanized tire grinds for large scale manufacture of landscaping mulch and playground protective surfaces would be greatly enhanced by using a low cost, safe, and nontoxic coloring process that provides uniform coloration as well as color durability and permanence. Since utilization of scrap tire particles is based on both performance and appearance, efficient coloring of scrap tire grinds would enhance aesthetic value considerably. Consequently, there is a need for an effective method of coloring vulcanized. rubber particles that provides a more durable and more uniform color coating on such materials.

### SUMMARY OF THE INVENTION

The present invention is generally directed to the manufacture of colorized rubber, particularly vulcanized rubber or rubber particles, the products formed thereby, and methods of using same as mulch. It is an object of this invention to provide a process that: delivers aqueous based colorant to vulcanized rubber particles in the form of an aqueous pigment dispersion (waterborne coating); and seals (encapsulates) the colorant onto the vulcanized rubber particles by the use of an aqueous based emulsion polymer. It is a further object of this invention to provide aqueous pigment dispersions and sealing systems that are nontoxic and friendly to the environment.

This invention relates to a method for preparing colored rubber particles useful as safety surfaces for playgrounds and as landscaping mulch. According to the present invention, vulcanized rubber particles are mixed with an aqueous pigment dispersion and an emulsion polymer is added to encapsulate the color coated rubber particles. The encapsulated rubber particles are then allowed to dry to form a protective film around the color coated rubber particles.

More specifically, the present invention provides a method for substantially uniform coloring of vulcanized rubber particles and allows for the use of a wide variety of colors derived from both inorganic and organic pigments. The present invention preferably includes an independent step of coating colored vulcanized rubber particles with a protective polymeric film. The polymeric coating materials are chosen from groups known to provide durable and flexible coatings. Further, the overall performance of these polymeric coatings in providing adhesion of the pigment to vulcanized rubber particles is maximized either by choosing an elastomer based on electronic and/or steric interactions with the pigment and vulcanized rubber particles or by use of a polymer capable of self-crosslinking to form a protective three dimensional network that binds pigment to vulcanized rubber particles.

In a preferred embodiment of the present invention, a protective polymeric coating that encapsulates colored rubber particles is added in a post addition step after the pigment has been applied. This embodiment is especially advantageous since it enables specific tailoring of the polymeric component to the chemical type of pigment employed as well as maximization of the efficiency of the coloring process prior to application of the polymeric coating. Additionally, the method of the present invention allows one to independently control the concentration of the polymeric component relative to the pigment, thereby enhancing color durability. Depending on the type of vulcanized rubber particles used, and the surface roughness and fiber content of the particles, it may be desirable to add part of the emulsion polymer to the vulcanized rubber particles before adding the aqueous pigment dispersion. The balance of the emulsion polymer is then added after adding the aqueous pigment dispersion.

Embodiments of the invention disclosed herein also relate to colored vulcanized rubber particles having outstanding color stability and abrasion resistance. The colored vulcanized rubber particles of the present invention are comprised of rubber particles having a color coating thereon. The colored rubber particles of the present invention are useful as playground safety surfaces as these particles: meet the demanding physical requirements of playground safety surfaces; provide the cushioning properties required for such use; and retain color permanence and durability. The colored vulcanized rubber particles disclosed herein are particularly useful as landscaping mulch.

The present invention provides colored vulcanized rubber particles useful for playground safety surfaces and landscaping mulch with substantially uniform colorfastness and resistance to ultraviolet light, and outstanding color durability and abrasion resistance upon exposure to aqueous environments.

These and other objects together with the advantages thereof over known methods of coloring rubber products will become apparent from the detailed description which follows and are accomplished by the invention as hereinafter described and claimed.

One embodiment of the present invention is a surface material comprising vulcanized rubber particles, a color coating covering said vulcanized rubber particles, and a polymer coating covering said color coating to thereby form abrasion resistant surface material. The surface may be a playground surface or used as landscaping mulch. The color coating may comprise an organic pigment or an inorganic pigment. The color coating may also further comprise an opacifying pigment, an extender, and a nonionic and/or an anionic surfactant. The protective polymer coating may be selected from the group consisting of fully-saturated polyacrylate co/terpolymer, a self-crosslinking functionalized polyacrylate multipolymer, a polyurethane, a styrene/butadiene rubber, or a polybutadiene rubber. The surface material may further comprise an ultraviolet light absorber, an ultraviolet light quencher, a hindered amine light stabilizer, an antioxidant, or an antiozonate.

Another embodiment of the present invention is a method of preparing colored rubber particles comprising the steps of: mixing vulcanized rubber particles with an aqueous pigment dispersion to color coat the rubber particles thereby forming color coated rubber particles; and adding an emulsion polymer to the color coated rubber particles to form a protective film around the color coated rubber particles. The method may further comprise heating the color coated rubber particles. The aqueous pigment dispersion may further comprise one or more of the following: an extender, a rheological agent and an opacifying pigment. Preferably, the amount of the aqueous pigment dispersion in the mixture is about 0.01 to 8.00 weight percent of the vulcanized rubber particles. More preferably, the amount of the aqueous pigment dispersion in the mixture is about 0.05 to 6.00 weight percent of the vulcanized rubber particles. Most preferably, the amount of the aqueous pigment dispersion in the mixture is about 0.10 to 5.00 weight percent of the vulcanized rubber particles.

The aqueous pigment dispersion may comprise an aqueous organic pigment dispersion or an aqueous inorganic pigment dispersion. The aqueous organic pigment dispersion may further comprise an anionic and a nonanionic surfactant. Preferably, the aqueous organic pigment dispersion has a total solids content of about 30 to 60 percent. More preferably, the aqueous organic pigment dispersion has a total solids content of about 32 to 55 percent. The aqueous inorganic pigment dispersion may further comprise an anionic and a nonionic surfactant. The aqueous inorganic pigment dispersion may further comprise an extender, a Theological agent, and an opacifying pigment. Preferably, the aqueous inorganic pigment dispersion has a total solids content of about 25 to 55 percent. More preferably, the aqueous organic pigment dispersion has a total solids content of about 30 to 50 percent.

The emulsion polymer may be selected from the group consisting of styrene/butadiene rubber, polybutadiene rubber, a fully saturated polyacrylate co/terpolymer, or a self-croslinking functionalized polyacrylate multipolymer. The emulsion polymer has a T_{g} in the range of about −70° C. to 20° C. The emulsion polymer may comprise a polymer capable of bonding with the aqueous organic or inorganic pigment dispersion.

Another embodiment of the present invention provides a method of converting vulcanized rubber into surface covering material comprising grinding vulcanized rubber into rubber particles; mixing the rubber particles with an aqueous pigment dispersion to form mixture; stirring the mixture to color coat the rubber particles thereby forming color coated rubber particles; and adding an emulsion polymer to the color coated rubber particles to encapsulate the color coated rubber particles and form a protective film around the color coated rubber particles. The vulcanized rubber may come from scrap tires. The aqueous pigment dispersion may comprise a pigment and an aqueous dispersant.

### DETAILED DESCRIPTION OF THE INVENTION

Sulfur vulcanization is the most common approach for producing rubber compounds with properties suitable for tire applications. The operative mechanism for sulfur vulcanization was originally thought to be free radical, but later work points to an ionic mechanism. Regardless of the operative mechanism, key structural moieties in vulcanized rubber are

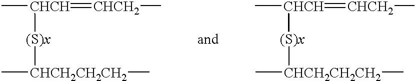

where x is a small number. There may also be a few residual unsaturation sites from parts of elastomer backbones not involved in the vulcanization reaction.

While not wishing to be bound by theory, rubber coloring can be achieved as a consequence of electronic interactions between the pigment, and the residual unsaturation and sulfur linkages in vulcanized rubber. However, the nature of these electronic interactions is weak. Because only unshared electron pairs on the sulfur atoms and/or pi-bond orbital overlap of the residual unsaturation are involved with the polar sites of the pigment there are no direct covalent bonds formed between the pigment and the available sites on the vulcanized rubber. Because of these weak electronic interactions, it is generally observed that adhesion of pigment to vulcanized rubber particles is marginal to poor. This leads to unsatisfactory performance of colored vulcanized rubber particles, particularly with regard to properties such as color abrasion resistance and color permanence when exposed to aqueous environments in applications such as protective surfaces for playgrounds and landscaping mulch.

One aspect of the invention to provide a method of preparing colored rubber particles from vulcanized rubber particles that exhibit excellent abrasion resistance and color permanence when exposed to aqueous environments. In this embodiment, vulcanized rubber particles are mixed with an aqueous pigment dispersion to form a color coating on the rubber particles. An emulsion polymer is then added to the color coated rubber particles to encapsulate the color coated rubber particles. The encapsulated color coated rubber particles are then allowed to dry to form a protective film around the color coated rubber particles.

Vulcanized rubber particles made from scrap tire grinds are available in various sizes and shapes depending on the application. Generally, the largest pieces of chunk rubber used in the present invention are irregular shapes measuring about ¾ to 1 inch in length with a thickness in the range of about ⅛ to 3/16 inch. Long, thin pieces of vulcanized rubber (known in the art as buffings) used in the present invention measure about 1 to 2 inches in length and have an average diameter of about 1/16 to ⅛ inch. Preferably, rubber buffings are used in admixture with chunk rubber pieces to prepare the landscaping material of the present invention. It is also preferable to use rubber nuggets measuring about ⅜ of an inch in length for the playground safety surface materials of the present invention. It is to be understood, however, that other sizes of vulcanized rubber particles may be used.

Both organic and inorganic pigments may be used to form the pigment dispersions described herein. Organic pigments offer a wide range of brilliant colors and are much more expensive than inorganic pigments. For reasons of economy, organic pigments are generally used at much lower concentrations than inorganic pigments. Typically, organic pigments are conjugated structures, optionally complexed with metal atoms. Copper phthalocyanine is a very well known organic pigment, and is useful for providing brilliant blue coloration to the colored vulcanized rubber particles of the present invention. The structure of copper phthalocyanine is depicted below:

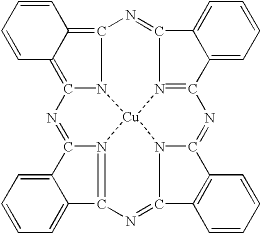

Although not wishing to be bound by theory, it appears that this complexed conjugated structure can exhibit electronic interactions with the vulcanized rubber structure shown above through pi-bond orbital overlap of the C═N unsaturated moieties with the residual unsaturation. Weak interactions between the aromatic nuclei of the copper phthalocyanine and the residual unsaturation of the vulcanized rubber, as well as interactions of the copper atom with the sulfur bonds, is also possible. Steric interactions are minimized due to the planarity of the copper phthalocyanine molecule thereby enabling requisite proximate approach of the pigment molecule to the locus of the crosslinked vulcanized rubber structure.

Like other organic pigments, copper phthalocyanine exists in various crystalline modifications. Copper phthalocyanine with color index name C.I. Pigment Blue 15:3 and C.I. Pigment Blue 15 are preferred for use in the present invention.

In addition to copper phthalocyanine to produce blue vulcanized rubber particles, other organic pigments may be employed in the present invention. For example, chlorinated copper phthalocyanine (color index name C.I. Pigment Green 7) can be used to produce a medium green color. Violet can be derived from the dioxazine family, from a material known as 8,18-dichloro-5,15-diethyl-5,15-dihydrodiindolo[3,2-b:3′,2′-m]phenodioxazine (C.I. Pigment Violet 23). Organic pigment dispersions may be used singly or blended together to produce many different colors and shades of color.

Aqueous dispersions of organic pigments may be prepared in the presence of opacifying pigments such as titanium dioxide. Rutile grades of titanium dioxide have less tendency to chalk and are preferred over anatase grades. The aqueous dispersion may also contain other pigments such as zinc oxide and silicon dioxide as well as extenders such as calcium carbonate.

An important aspect of the present invention is the identification of efficient surfactants to promote the formation of high quality, relatively stable aqueous pigment dispersions. A high quality aqueous dispersion is essential to ensure uniform delivery of pigment molecules to the vulcanized rubber sites. An aqueous pigment dispersion capable of preventing premature settling and agglomeration of pigment and additives is desired. Surfactants especially suitable for the purpose of promoting high quality and stable aqueous dispersions for organic pigments are those selected from groups based on alkyloxypolyethyleneoxyethanols (secondary alcohol ethoxylates) and octylphenoxypolyethoxyethanols (alkylphenol hydroxypolyoxyethylenes). Examples of the first category of nonionic surfactants are Tergitol 15-S-7 and Tergitol 15-S-9. These surfactants are available commercially from Union Carbide Corporation, Danbury, Conn. 06817-0001. Union Carbide Corporation is now a subsidiary of The Dow Chemical Company, Midland, Mich. The structure of Tergitol surfactants can be represented as follows:

C₁₂₋₁₄H₂₅₋₂₉O(CH₂CH₂O)ₓH

where x=3-40.

Examples of the second category of nonionic surfactants are known as Triton X-45 and Triton X-100. These materials also are available commercially from Union Carbide Corporation. The structure of Triton surfactants is represented as follows:

C₈H₁₇C₆H₄O(CH₂CH₂O)ₓH

where x=1-55.

The above classes of nonionic surfactants can be used to prepare aqueous pigment dispersions for a variety of organic pigments. They can be used singly or in admixture with each other or in admixture with anionic surfactants. Low levels of other ingredients such as rheological agents, for example, may be required in admixture with the nonionic surfactants. Suitable rheological agents are hydroxy ethyl cellulose, carboxymethyl cellulose, and bentonite clays. Other materials such as lecithin and polyvinyl pyrrolidone may also be incorporated with the nonionic surfactants.

Addition of small amounts of these types of stable aqueous dispersions of organic pigment to vulcanized rubber granules followed by efficient mixing results in uniform color coverage of the rubber particles. The brightness of the color depends on the amount of titanium dioxide and the amount of extender used. Generally a brighter and lighter coloration is obtained with higher titanium dioxide concentrations. Many aesthetically pleasing shades of coloration on rubber particles can be obtained using various ratios of titanium dioxide and calcium carbonate.

The total solids content of stable aqueous organic pigment dispersions of the present invention is preferably in the range of 30% to 70%. More preferably, the total solids is in the range of 32% to 65%. The concentration of aqueous dispersions of copper phthalocyanine useful in the present invention ranges from 0.90 to 22.50 weight percent copper phthalocyanine. The preferred concentration range for copper phthalocyanine is 1.50 to 14.50 weight percent. The concentration of titanium dioxide (and optionally other pigments and extenders) ranges from 98.50 to 85.50 weight percent of the total solids content, and the preferred concentration range is 99.10 to 77.50 weight percent.

Aqueous organic pigment dispersions used in the present invention are added to vulcanized rubber granules in concentrations ranging from 0.01 to 8.00 weight percent with respect to the total weight of rubber particles. A more preferred range of aqueous organic pigment dispersion to be used with the rubber is 0.05 to 6.00 weight percent with respect to the total weight of rubber. A most preferred range of aqueous organic pigment dispersion to be used with the rubber is 0.10 to 5.00 weight percent with respect to the total weight of rubber.

Efficient mixing of the aqueous dispersion with vulcanized rubber granules is essential to achieve uniform pigment coverage of the rubber particles. On a laboratory scale, a helical or cylindrical mixer attached to a motor operating at speeds of between about 500 to 1700 rpm is sufficient to achieve good mixing and coverage of the rubber particles. On a large commercial scale, horizontal blenders with ribbon agitators are very efficient for mixing aqueous pigment dispersions onto the rubber particles. It is preferred to have the horizontal mixing chamber and ribbon agitators constructed of stainless steel. Mixing time of about 1-5 minutes, preferably 2-3 minutes, is generally sufficient to achieve good coverage in small laboratory equipment. In a 30 cubic foot Marion stainless steel mixer equipped with a stainless steel ribbon agitator, excellent coverage of 700 pounds of vulcanized rubber nuggets was achieved in as little as 3 minutes using a 0.25 weight percent aqueous pigment dispersion. Depending on the type of rubber particles used, it may be advisable to use either a paddle or plow agitator instead of a ribbon agitator to achieve good rubber/colorant mixing.

According to the preferred method of the present invention, an emulsion polymer is added to the colored vulcanized rubber particles to encapsulate the rubber particles and form a protective coating thereon. The coating formed by the methods of the present invention is very flexible to withstand harsh abrasion forces and possesses the ability to flex repeatedly with the natural resiliency of the rubber particles without cracking.

Since the aqueous pigment dispersion is applied to the rubber particles in an aqueous media, subsequent addition of the emulsion polymer is an ideal means of applying the protective film. Air drying or drying at somewhat elevated temperature produces a thin and integral polymeric film that coats the colored layer and bonds it to the rubber particle. Thus, a coated, colored rubber particle can be envisioned as a three component laminate structure. The tough and durable exterior polymeric film ensures and protects the uniformity of the color layer that is only weakly bonded to the vulcanized rubber particle. While the color layer on the rubber particle is uniform, it is not completely integral so that there are some rubber sites available for direct interaction or binding with the polymer. Hence, the polymeric film not only protects the color layer, but also is itself involved in some direct interaction and binding with the surface of the vulcanized rubber particle.

According to the present invention, the emulsion polymer can be added in a variety of ways. The aqueous pigment dispersion can be added to the vulcanized rubber particles first. The emulsion polymer is then added in a second, separate step. The advantage of this method is that the concentration of the polymer is independent of the concentration of the pigment. Alternatively, part of the emulsion polymer can be added to the vulcanized rubber particles, followed by addition of the aqueous pigment dispersion. The balance of the emulsion polymer is then added after addition of the aqueous pigment dispersion. This method may be desirable if the rubber particles have relatively rough surfaces and relatively high fiber content. The ability to control the emulsion polymer concentration separately from the pigment concentration is an important factor in improving color abrasion and durability of certain types of pigments in coloring vulcanized rubber particles.

When the emulsion polymer is an elastomer, there are at least two fundamental features of elastomer that need to be considered to meet the requirements herein described to promote color adhesion to vulcanized rubber particles. First, the chemical structure of the elastomer should possess moieties capable of entering into bonding interactions with the pigment. It may not always be possible to satisfy this feature fully since only minor bonding interactions may be extant. Second, the elastomer should possess a low glass transition temperature (T_{g}). The glass transition temperature is the temperature at which the amorphous domains of a polymer take on the characteristic properties of the glassy state, i.e., brittleness, stiffness, and rigidity. Accordingly, the lower the T_{g} of the polymer the more flexible the polymer chain becomes. Since flexibility of the elastomer coating is very important to protect the color layer, it is important that the elastomer possess a relatively low T_{g}.

With these criteria in mind, the choice of available elastomers to protect organic pigment layers on vulcanized rubber particles is influenced by the structure of the colorant. For example, use of copper phthalocyanine as an organic pigment to color vulcanized rubber particles points to elastomers in the styrene/butadiene (SBR) family. This is because the structural similarities between SBR and copper phthalocyanine promote bonding interactions. Moreover, the aromatic moieties in SBR elastomer show favorable bonding interactions with the aromatic moieties in copper phthalocyanine. Additionally, there are numerous SBR elastomers that exhibit reasonably low T_{g}. Thus, it is preferable to use SBR latexes with low T_{g} with organic pigments. In cases where the use of SBR rubber is not practical, certain polyacrylic type latexes can be used with organic pigments.

There are many SBR elastomers available commercially since they are used routinely as an important initial rubber source in tire manufacture. The BF Goodrich Company, Cleveland, Ohio offers a family of SBR latices formulated, for example, by carboxylation to exhibit various degrees of adhesion to substrates. These rubbers exhibit reasonably low glass transition temperatures (−23° C. to +17° C.).

In addition to the use of organic pigments, the present invention also utilizes inorganic pigments to achieve more earth tone types of colors primarily for landscaping mulch applications. These inorganic pigments are based mainly on iron oxides and are typically available in red, brown, and yellow colors. There are other colors available based on different inorganic oxides.

A copolymer available from Rohm and Haas Company, Philadelphia, Pa. is effective as a dispersant to form stable aqueous dispersions of the inorganic pigments. The dispersant is referred to as Tamol 1124 (also called Orotan 1124) and is available as an approximate 50% solution in water. Variants of anionic polyacrylic acid and esters can be used to disperse inorganic pigments. Anionic surfactants such as sodium dioctylsulfosuccinate, ammonium lauryl sulfate, sodium lauryl sulfate, and sodium dodecylbenzenesulfonate may be used to disperse inorganic pigments. The effectiveness of these materials and other anionic surfactants may be improved by incorporation of Theological agents such as hydroxyethyl cellulose, ethyl hydroxyethyl cellulose, carboxymethyl cellulose, and bentonite clays. Other materials such as lecithin and polyvinyl pyrrolidone may be incorporated with these anionic surfactants. The aqueous dispersion may also contain other pigments such as titanium dioxide, zinc oxide and/or silicon dioxide as well as extenders such as calcium carbonate.

Addition of low levels of these types of stable aqueous dispersions of inorganic pigment to vulcanized rubber particles provides uniform coloring. Optional use of titanium dioxide with inorganic pigments lightens the coloration slightly. Addition of titanium dioxide pigment is preferred with lighter inorganic pigment dispersions to attenuate the inherent black coloration of the vulcanized rubber particles. In some cases, extension with calcium carbonate may be used to lower overall pigment costs.

The total solids content of stable aqueous inorganic pigment dispersions of the present invention is preferably in the range of about 25% to 65%. A more preferred total solids is in the range of about 30% to 60%. Of the solids content in a stable aqueous dispersion of iron oxide used in the present invention, the concentration of iron oxide is in the range of about 50 to 100 weight percent. The preferred concentration range for iron oxide is about 73 to 90 weight percent. The concentration of titanium dioxide (and optionally other pigments and/or extenders) when used ranges from about 27 to 40 weight percent. However, it is understood that inorganic oxide pigment may be used alone as the active colorant in aqueous inorganic pigment dispersions without the use of titanium dioxide and extenders.

Binding of inorganic pigments to vulcanized rubber particles is marginal due to the weak interactions between the metal atoms and the unshared pairs of electrons on the oxygen atoms with the available sulfur and residual unsaturation sites on the vulcanized rubber. The extent of binding may be less than that observed with organic pigments. Accordingly, color adhesion of inorganic metal oxides to vulcanized rubber particles is generally inferior to that observed with organic pigments.

The structure of iron oxide, for example, is not as conducive to electronic interactions with elastomers such as SBR as is the case for copper phthalocyanine. With the prospects for significant electronic interactions between elastomer and iron oxide diminished, it is evident that different factors may need to be considered in choosing an elastomer to provide color adhesion of iron oxide and other inorganic pigments to vulcanized rubber particles.

In the present invention, use of iron oxide as an inorganic pigment to color vulcanized rubber particles favors a tough, integral elastomeric film with a low glass transition temperature for color durability. The elastomer film must be flexible and capable of exhibiting substantial deformation and recovery. With the lack of significant bonding interactions between elastomer and iron oxide, a tough and very elastic elastomeric film is required to encapsulate the colored rubber particles of the present invention. Further, since the iron oxide coating is not completely uniform, there are sites available for direct bonding of the elastomer to the vulcanized rubber.

These types of requirements and restrictions to achieve color adhesion and abrasion resistance of inorganic pigments to vulcanized rubber point to the use of acrylic or other elastomers with low T_{g} values. The B F Goodrich Company, Cleveland, Ohio offers a family of acrylic latices designed to exhibit outstanding adhesion properties to substrates due to their very low T_{g} values. Specially designed acrylic elastomers in this family exhibit T_{g}s as low as −60° C. Other acrylic elastomers are available with low glass transition values ranging from about −43° C. to −23° C. Certain polybutadiene (PBD) elastomers also exhibit very low T_{g} values.

Binding interactions between elastomer, pigment and vulcanized rubber particles are generally enhanced by the application of heat as in, for example, the drying step. Accordingly, performance characteristics such as tendency for color to leach into hot water (color stability) usually improve upon the application of heat. In laboratory tests, portions of the colored and coated nuggets were air dried and portions were oven dried. In manufacturing operations such as use of large blenders equipped with ribbon, paddle or plow agitators, drying can be accomplished in the blender itself after the addition of the pigment dispersion and the emulsion polymer by use of a heated jacketed device. This is possible because the concentration of water in the mixture is low, generally not greater than about 3 to 4 weight percent. In this example, the heated jacket is adjusted such that the temperature of the mixture is close to the boiling point of water, e.g., about 90-95° C. Preferably, the rubber particles are heated prior to addition of pigment and elastomer.

Alternatively, the colored and coated particles can be removed from an unjacketed blender and dried separately using a vibrating conveyor belt passing through a bank of infrared heaters, a fluid bed dryer, or other conventional means of drying. Depending on the nature of the emulsion polymer, it is possible in some cases for colored and coated vulcanized rubber particles to demonstrate good color durability with simple air drying. The choice of these production methods will depend on overall product quality, production volumes, and comparative economics.

Another means of achieving outstanding color durability and abrasion resistance of colored vulcanized rubber particles using either organic or inorganic pigments is subsequent utilization of selected emulsion polymers capable of forming three dimensional networks. One such example is Esi-Cryl 1000XL, available from Cook Composites and Polymers Company, 820 East 14^{th} Avenue, North, Kansas City, Mo. 64116.

Esi-Cryl 1000XL is a linear, acrylic based emulsion polymer (T_{g}˜15° C.) with a solids content of about 40% that self-crosslinks to a three dimensional network upon removal of water. When added to colored vulcanized rubber particles in a second distinct step, this emulsion polymer forms a tough, durable, integral film that encapsulates the colored rubber particle after the water is removed. This represents another means of binding color onto vulcanized rubber particles. The higher degree of water removal, the more extensive is the crosslinked network, three-dimensional network. It is evident that formation of a more extensive crosslinked network will result in a higher extent of sealing/encapsulation and thereby a higher degree of color durability and color abrasion resistance of the colored vulcanized rubber particles. Time required for a reasonable degree of crosslinking typically is at least 24 hours at air-drying (˜25° C.) conditions. A more extensive three-dimensional network to provide a further degree of binding/protection to colored vulcanized rubber particles may be achieved if drying is used to facilitate water removal. Drying for a few minutes at 50-130° C. using equipment described above should provide exceptional color durability and color abrasion resistance of colored vulcanized rubber particles.

Depending on the type of vulcanized rubber to be colored, its surface characteristics, the type of pigment(s) and surfactant(s) used, and the total solids content, it is envisioned that the Esi-Cryl polymer emulsion may be added to the aqueous pigment dispersion prior to rubber coloring/sealing. This one step approach would offer an element of process simplicity. Overall effectiveness of the one step process would need to be carefully determined compared to that of the two steps process especially in terms of vulcanized rubber color durability and color adhesion/abrasion resistance performance.

In order to demonstrate the method of the present invention, examples showing preparation of aqueous pigment dispersions, coloring of vulcanized rubber particles, and coating of colored rubber particles with emulsion polymers are described below.

Preparation of Aqueous Organic Pigment Dispersions of Copper Phthalocyanine

1.00 g Tergitol 15-S-9 and 75.00 g distilled water are added to a 600 ml beaker equipped with a magnetic stirring bar. Tap water can also be used in these formulations but distilled water is preferred. The mixture is stirred on a magnetic stirrer until homogeneous and one drop Dow FG 10 antifoam is added to eliminate the foam head. 5.00 g of copper phthalocyanine is slowly added over three minutes with good agitation until a good dispersion with a deep dark blue coloration is achieved. With good agitation, 32.00 g calcium carbonate (Omyacarb UF) and 32.00 g titanium dioxide (Kronos 2020 Rutile Grade) are then added to this mixture over five minutes. The resulting dispersion is a medium robin egg blue.

One weight percent of this organic dispersion is used to color vulcanized rubber particles. The dispersion is always shaken or stirred before each use. The resulting aqueous dispersion is stable and shows practically no settling on standing at room temperature for 24 hours. Long term storage stability of the dispersion would likely be improved by using more efficient, higher speed mixing.

Preparation of Aqueous Inorganic Pigment Dispersion of Red Iron Oxide

0.90 g Orotan 1124, 0.10 g bentonite clay (Suspengel Elite), and 75.00 g distilled water are added to a 600 ml beaker equipped with a magnetic stirring bar are added. The mixture is stirred on a magnetic stirrer until homogeneous with a very slight haze. One drop of Dow FG 10 antifoam is added to eliminate the foam head. 75.00 g of red iron oxide (Bayer Corporation, Pittsburgh, Pa.) is added slowly over five minutes. The resulting dispersion is a deep dark orange red.

One weight percent of this inorganic dispersion is used to color vulcanized rubber particles. The dispersion is always shaken or stirred before each use. The resulting aqueous dispersion is stable and shows little settling on standing at room temperature for 24 hours. Long term storage stability of the dispersion likely would be improved by using more efficient, higher speed mixing.

Coloring and Polymer Coating of Vulcanized Rubber Particles

A shaft connected to a cylindrical mixer is attached to a drill press. The cylindrical mixer is ribbed and measures 3.72 inches high with a diameter of 3.09 inches. Changing the size of the pulleys connected by a belt can alter the speed of the drill press. The speed is set to 500 rpm.

1350 g rubber nuggets which measure approximately ⅜ of an inch are added to a high density polyethylene 11 quart pail is added. The pail containing the nuggets is positioned so that the bottom of the cylinder is about one half inch from the bottom of the pail. One weight percent (with respect to the weight of rubber nuggets) of copper phthalocyanine aqueous dispersion is added and is mixed with the nuggets for two minutes. During this time the pail is moved about the stirrer to maximize the contact between the rubber nuggets and the aqueous pigment dispersion. At the end of this time the color coverage was quite uniform, and the rubber nuggets were colored medium robin egg blue.

The emulsion polymer was immediately added after coloring. In the case of SBR, 10 g of rubber (18.83 g of latex, 53.1% total solids) was added after diluting the latex with 20 g of water. Stirring continued an additional two minutes after the diluted emulsion polymer was added. In the case of acrylic elastomer, 10 g of rubber (20.24 g of latex, 49.4% total solids) was added after the latex was diluted with 20 g of water. Stirring continued an additional two minutes after the diluted emulsion polymer was added. In the case of Esi-Cryl 1000XL 16.2 g (1.2%) of this emulsion (40% solids) was added, stirring continued an additional one minute.

The coloring procedure was repeated except that one weight percent (13.5 g) of red iron oxide aqueous dispersion was added to 1350 g rubber nuggets. Color coverage was again quite uniform, and the rubber nuggets were colored dark orange red after two minutes of stirring. The colored rubber particles were coated with 10 g SBR as described for the case using copper phthalocyanine. The colored rubber particles were also coated with 10 g acrylic rubber for the case using red iron oxide. The same elastomer coating procedure as described for the case of copper phthalocyanine was used. When Esi-Cryl 1000X was used to coat red iron oxide, its concentration generally is in the 0.75-1.0 Wt % range, stirring continued an additional one minute.

It is anticipated that this same type of approach to coloring and subsequent polymer coating of vulcanized rubber granules should be applicable to many different types of pigments, elastomers, and Esi-Cryl 1000XL.

The coloring and coating experiments are summarized in Table I.

TABLE I
Coloring and Polymer Coating of Vulcanized Rubber Particles

| | | Colorant | | |
|---|---|---|---|---|
| | | Concentration | | |
| | | Added to | | |
| | | Rubber | | |
| Expt. No | Colorant | Nuggets, wt % | Elastomer | T_{g}° C. |
| 1 | Copper | 0.03448 | SBR | −23 |
| | Phthalocyanine | | elastomer^{2, 3} | |
| 2 | Copper | 0.03448 | acrylic | −43 |
| | Phthalocyanine | | elastomer^{2, 3} | |
| 3 | Red Iron Oxide | 0.4967 | SBR | −23 |
| | | | elastomer^{2, 3} | |
| 4 | Red Iron Oxide | 0.4967 | acrylic | −43 |
| | | | elastomer^{2, 3} | |
| 5 | Copper | 0.03448 | Esi-Cryl⁴ | +15 |
| | Phthalocyanine | | 1000XL | |
| 6 | Red Iron Oxide | 0.2500 | Esi-Cryl⁵ | +15 |
| | | | 1000XL | |

¹1350 g of ⅜ inch rubber nuggets (source: Tire Depot, Inc., Morehead, MN) colored and coated
²Elastomer ˜50% solids added at 1.0 Wt % with respect to rubber
³Elastomer source: The BF Goodrich Company, Cleveland, Ohio
⁴Esi-Cryl source: Cook Composites and Polymers Co., North Kansas City, Missouri; added at Wt % with respect to rubber
⁵Esi-Cryl 1000XL added at 0.75 Wt % with respect to rubber

Each of the color coated vulcanized rubber products were dried two different ways. A portion was air dried at room temperature for 18 hours and another portion was oven dried at between about 110-120° C. for ten minutes. The color stability test was performed by heating and stirring dried colored and coated nuggets in water to about 75-80° C. from room temperature over 15 minutes and observing the color/clarity of the aqueous effluent. The color abrasion test was performed by taking several nuggets, rubbing them vigorously on a white paper background, and observing if the color rubs off onto the paper. Both the color stability and abrasion tests are much more severe than would be observed in normal use conditions.

As a general rule, it was observed that the color of the air dried nuggets did not change when the nuggets were oven dried.

It is evident from Table I that the concentration of copper phthalocyanine used to color vulcanized rubber particles is far less than the concentration of red iron oxide used. This reflects a higher coloring capacity of copper phthalocyanine compared to red iron oxide. The concentration of red iron oxide used on a weight basis is 14.4 times that of copper phthalocyanine. Since the same weight percentage of both SBR and acrylic rubber was used to coat the colored rubber particles, it is apparent that the relative ratio of rubber to pigment is much higher in the case of copper phthalocyanine. The rubber/pigment ratios are 21.47 and 1.49 for copper phthalocyanine and red iron oxide, respectively. Hence, the elastomer layer covering copper phthalocyanine colored vulcanized rubber particles is thicker than the elastomer layer covering the red iron oxide. The situation is similar when Esi-Cryl is used to coat the rubber particles.

The results of color stability and color abrasion testing for air dried and oven dried colored and coated vulcanized rubber particles are summarized in Table II.

TABLE II
Color Stability and Abrasion Resistance of Colored and Coated
Vulcanized Rubber Products

| | Method of Drying | | Appearance | |
|---|---|---|---|---|
| | Air Dry @ | Oven | of Aqueous | Color |
| | Rm. Temp | Dry @ | Effluent from | Abrasion |
| Expt. No.¹ | 18 hrs | 110-120° C. | Color Stability Test² | Test³ |
| 1 | x | | v. slight haze; no | color does |
| | | | color | not rub off |
| 1 | | x | essentially clear; no | color does |
| | | | color | not rub off |
| 2 | x | | slight haze; no color | color does |
| | | | | not rub off |
| 2 | | x | almost clear; no | color does |
| | | | color | not rub off |
| 3 | x | | hazy and dark red | color rubs |
| | | | | off |
| 3 | | x | hazy and red | less color |
| | | | | rubs off |
| | | | | than oven |
| | | | | dry |
| 4 | x | | clear; very light | color does |
| | | | pink | not rub off |
| 4 | | x | clear; almost color- | color does |
| | | | less | not rub off |
| 5 | x | | clear; almost color- | color does |
| | | | less | not rub off |
| 5 | | x | clear; colorless | color does |
| | | | | not rub off |
| 6 | x | | clear; very light | color does |
| | | | pink | not rub off |
| 6 | | x | | color does |
| | | | | not rub off |

¹Experiment numbers and materials are the same as those in Table I.
²Colored and coated nuggets (20 g) added to 200 g water; mixture heated with stirring from ambient temperature to ˜80° C.-100° C. over 15 minutes.
³Colored and coated nuggets rubbed vigorously on white paper background.

From the data in Table II it is apparent that application of heat to dry the colored and coated vulcanized rubber particles is beneficial for color stability for all combinations of pigment and polymer coatings tested. Accordingly, although good color stability can be achieved in some cases with air drying, use of heat to dry colored and coated particles is preferred.

It is significant that copper phthalocyanine is not extracted into hot (−80° C.) water regardless of whether the colored and coated rubber particles are air dried or oven dried. The haze observed in the aqueous effluent for oven dried samples is due to some extraction of titanium dioxide and/or calcium carbonate into the effluent. Additionally, the blue color does not rub off particles that are either air or oven dried. This suggests that the elastomer coating over the copper phthalocyanine layer is generally uniform. While differences between the coating performance of SBR and acrylic rubber are minimal for copper phthalocyanine, the use of SBR over acrylic rubber is slightly preferred. This may be due to more effective electronic interactions between SBR elastomer and copper phthalocyanine than between acrylic elastomer and copper phthalocyanine. Elastomer interactions with the vulcanized rubber may also be a factor.

In contrast to the data for copper phthalocyanine, the results for use of red iron oxide are quite different. The performance of SBR elastomer is inferior to that of acrylic elastomer in protecting red iron oxide in terms color stability and color abrasion resistance. Whether the product is air dried or oven dried, there is considerable haze in the water effluent after the hot (80° C.) water color stability test. Color abrasion with the SBR coating on red iron oxide is also inferior. The color rubs off easily for the air dried sample, and there is still some color rub off for the oven dried sample.

The acrylic rubber coating offers good protection for red iron oxide. The color stability test gave a clear aqueous effluent for both air and oven dried samples. There is a very light pink coloration in the aqueous effluent for the air dried sample, and almost no color in the aqueous effluent for the oven dried sample. Color abrasion was good for both the air dried and oven dried materials since the color did not rub off in either case.

The lack of color stability and poor abrasion resistance for vulcanized rubber particles colored with red iron oxide and coated with SBR elastomer suggests that bonding interactions between the elastomer and the pigment may be poor. There is probably little opportunity for significant bonding between iron oxide and SBR elastomer.

The superior performance of the acrylic rubber compared to that of SBR for protecting red iron oxide is likely not a consequence of bonding interactions since these interactions are relatively minor for the acrylic rubber/pigment situation. Rather, the encouraging results with acrylic elastomer protecting red iron oxide pigment may be a result of better mechanical properties of the acrylic elastomers as compared to the SBR elastomers. The T_{g} of the acrylic elastomers (−43° C.) is considerably lower than the T_{g} of the SBR elastomer (−23° C.). The lower the T_{g} of the elastomer, the more elastic and flexible the elastomer. The lower T_{g} of the acrylic elastomer may promote a tough, integral and flexible film coating that resists cracking under an applied load such as severe abrasion.

Table III illustrates the comparison of processes to color/polymer coat vulcanized rubber particles.

TABLE III
Comparison of Processes to Color/Polymer Coat Vulcanized Rubber
Particles

| Colored¹/Polymer Coated | | |
|---|---|---|
| Vulcanized Rubber Particle | | Color |
| System (wt. % dispersion/ | | Abrasion |
| emulsion Polymer) | Color Stability² | Resistance³ |
| 1. red alone (1.00/0) | very dark red, almost opaque | much color |
| | effluent | very easily |
| | | rubs off |
| 2. red + SBR-one step | dark red, hazy effluent | substantial |
| (1.00/1.39) | | color rubs |
| | | off |
| 3. red + SBR-two step | dark red, hazy effluent | some color |
| (1.00/1.39) | | rubs off |
| 4. red + Esi-Cryl 1000XL | very faint red, clear effluent* | slight color |
| -one step (0.75/1.00) | | rubs off |
| 5. red + Esi-Cryl 1000XL | very light pink, clear effluent | no color |
| -two step (1.00/0.70) | | rubs off |

¹Pigment is red iron oxide (Bayferrox) available from Bayer Corporation, Pittsburgh, PA.
²Appearance of air-dried colored and coated rubber nuggets (20 g) added to 200 g H₂O after treatment. Mixture stirred from ambient temperature to ˜80-100° C. for 15 minutes.
³After vigorously rubbing air-dried color coated nuggets on white paper.
*From nuggets colored and polymer coated with 0.50/0.50 Wt. % dispersion/emulsion polymer.

Table III illustrates the progression from use of colorant alone (no polymer coating) to use of red colorant with SBR in both a one step and two step process, and finally to use of red colorant with Esi-Cryl 1000XL in both a one step and two step process.

Color abrasion resistance (as determined by rubbing color/polymer coated rubber particles on white paper) is the most definitive test so show differences although color stability data also are included. There is noticeable improvement in color abrasion resistance on going from use of no protective polymer coating to use of SBR in a one step and two step process and finally to use of Esi-Cryl in a one step and two step process.

The data shows that the two step Esi-Cryl process is preferred, although in some applications the one step Esi-Cryl processes may be acceptable. Both the one step and two step Esi-Cryl processes are better in terms of color stability and color abrasion resistance than the one step and two step processes involving SBR. This is in spite of the fact the higher concentration of SBR (1.39 Wt %) is used compared to 0.70-1.00 Wt. % for Esi-Cryl.

Note that in the two step process use of higher colorant and lower Esi-Cryl (1.00-0.70) is superior to the one step process with lower colorant and higher Esi-Cryl content (0.75/1.00). This suggests in the one step process there is competition between colorant and Esi-Cryl molecules for uncolored rubber particles occurring at the same time. In contrast, in the two step process competition is notably less since a much higher proportion of the colorant is already bonded to the surface of rubber particles before the Esi-Cryl is added. Hence, when Esi-Cryl is added in the second step, much more of it is available to form a thicker protective polymer coating over the colorant coating than there is when a one step process is used. This is because there is far less competition from surfaces of rubber particles for the Esi-Cryl in a two step process versus a one step process.

All data are for air dried samples. Drying by heating even for only a short time will helpful for both color stability and color abrasion resistance performance features. Drying is especially beneficial when Esi-Cryl is used since it facilitates the formation of a more extensive three-dimensional network (that functions as a protective shell for the colored rubber) as water is removed. Three dimensional (crosslinked) networks are always preferred compared to linear, two dimensional systems (such as uncrosslinked SBR) as a protective coating for many substrates due to enhancement of a variety of important performance characteristics.

Color abrasion resistance and color stability are advantaged by use of three-dimensional networks such as those formed from Esi-Cryl. As the data show, even air-drying is beneficial when Esi-Cryl is used especially in a two step process compared to use of SBR in a two step process. In contrast to air drying, accelerated drying with heat (to perhaps 150-225° F.) will result in formation of a far more extensive three dimensional network with Esi-Cryl and consequently a more durable, protective coating for colored vulcanized rubber particles. When SBR is used, drying normally will not result in the formation of a three dimensional network. A linear, two-dimensional film usually is formed. A three dimensional network from SBR can be formed when it is functionalized, for example by inclusing of hydroxyl/carboxyl groups. The resulting network, however, generally is not as durable as that offered by Esi-Cryl which is based on acrylic polymer.

It should now be evident that many different organic and inorganic pigments can be used to color vulcanized rubber particles in the present invention. It is especially significant that the addition of emulsion polymers as a separate and distinct step relative to the pigment addition step is key in protecting the integrity of the pigment coating on the rubber particles. When elastomer is used, it is also clear that the type of elastomer used to maximize color stability and color abrasion resistance of the vulcanized rubber particles may depend on the type of pigment used. In some cases inherent structural features of the elastomer promote electronic/steric interactions with the pigment, and these are important criteria that help guide rubber choice for optimum preservation of color stability and color abrasion resistance. In other cases elastomer structural features responsible for the attainment of low glass transition temperature (T_{g}) to give tough, integral and very flexible films to coat/seal pigment to the vulcanized rubber particle are key for optimum preservation of color stability and color abrasion resistance.

The situation using Esi-Cryl 1000XL is different than when either SBR or acrylic elastomer is used. This is because Esi-Cryl 1000XL self crosslinks to form a three dimensional network that can effectively encapsulate and seal colored vulcanized rubber particles. The use of drying at somewhat elevated temperature enables the formation of a more extensive three dimensional network in a much shorter reaction time from than when air drying is used. This type of enhanced three dimensional network results in a polymer coating that offers outstanding color durability and color abrasion/adhesion resistance to colored vulcanized rubber particles.

Yet another aspect of the present that is expected is the achievement of color durability and color abrasion/adhesion resistance by use of polymers containing polyurethane units. Polyurethanes are known for their ability to offer outstanding mechanical and durability properties to many coating systems. The effectiveness of polyurethanes in coatings will depend on their chemical composition and concentration when used either as a homopolymer or as a co(multi)copolymer. The type of polyurethane as a polymer system that is substantially crosslinked or substantially linear can be important in determining suitability for a variety of coating applications.

Many types of polyurethanes can form the basis of coatings designed to impart superior protection to colored vulcanized rubber particles, particularly in terms of color abrasion resistance and color durability. Additionally, the polyurethane can be tailored to low glass transition temperature (T_{g}) so that the resulting coating is sufficiently flexible to withstand colored vulcanized rubber particle deformations in extreme outdoor climates (as low as −40° F. to −50° F.). The polyurethane coating also possesses sufficient thermal stability to withstand colored vulcanized rubber particle deformations in very warm outdoor climates (as high as +115° F. to +120° F.).

It is also within the spirit of the invention to address the potential problem of resistance to ultraviolet (UV) light. Outdoor exposure of colored and sealed vulcanized rubber particles presents special problems relating to the possibility of degradation due to UV exposure from sunlight. While pigments used in the present invention inherently possess good resistance to UV light (lightfastness), there is nonetheless the potential for degradation from them and other components. This is especially so considering the nature of the emulsion polymer used as well as the presence of ingredients in the raw rubber itself which can degrade by UV light.

It is important to address the potential problem of surface material resistance to UV light exposure. It is anticipated that improvement in UV light stability can be achieved by the addition of materials known to retard degradation from high energy UV radiation from sunlight. Accordingly, it is envisioned that colored and sealed vulcanized rubber particles of the present invention can be protected from damaging UV radiation from sunlight by the addition of materials known to retard this type of action. Use of UV absorbers that selectively absorb harmful UV radiation and re-emit it at a less harmful wavelength (mainly as heat) is desirable. Typical UV absorbers used in the present invention include alpha hydroxy benzophenones and alpha hydroxy benzotriazoles. Other additive may include hindered amine light stabilizers such as bis-(2,2,6,6-tetramethyl-4-piperidyl)sebacate. These materials function as free radical scavengers that lower the rate of chain oxidation reactions that lead to photo-oxidation degradation.

UV quenchers such as certain dimethylamino benzoates, and antioxidants such as 2,6-di-tert-butyl-4-substituted hindered phenols, various trialkylphosphites, and dialkylthioesters may be included either alone or in admixture with UV absorbers or hindered amine light stabilizers. Antiozonates may also be used.

Thus, it is believed that any of the variables disclosed herein can readily be determined and controlled without departing from the scope of the invention herein disclosed and described. Moreover, the scope of the invention shall include all modifications and variations that fall within the scope of the attached claims.

What is claimed is:

1. A surface material comprising:
vulcanized rubber particles;
a color coating covering said vulcanized rubber particles; and
a polymer coating covering said color coating to thereby form abrasion resistant surface material.

2. The surface material of claim 1, wherein said surface is a playground surface.

3. The surface material of claim 1, wherein said surface is landscaping mulch.

4. The surface material of claim 1, wherein said color coating is selected from the group consisting of an organic pigment and an inorganic pigment.

5. The surface material of claim 4, wherein said color coating further comprises an opacifying pigment, an extender, a nonionic surfactant, and an anionic surfactant.

6. The surface material of claim 1, further comprising an agent selected from the group consisting of an ultraviolet light absorber, an ultraviolet light quencher, a hindered amine light stabilizer, an antioxidant, and an antiozonate.

7. The surface material of claim 1, wherein said polymer coating is selected from the group consisting of fully-saturated polyacrylate co/terpolymer, polyurethane, self-crosslinking functionalized polyacrylate multipolymer, styrene/butadiene rubber, and polybutadiene rubber.

8. The surface material of claim 6, wherein said polymer encapsulates said vulcanized rubber particle.

9. A method of preparing colored rubber particles comprising:
mixing vulcanized rubber particles with an aqueous pigment dispersion to color coat said rubber particles thereby forming color coated rubber particles; and
adding an emulsion polymer to said color coated rubber particles to form a protective film around said color coated rubber particles.

10. The method of claim 9, further comprising heating the color coated rubber particles after the emulsion polymer has been added.

11. The method of claim 9, wherein said aqueous pigment dispersion is selected form the group consisting of an aqueous organic pigment dispersion and an aqueous inorganic pigment dispersion.

12. The method of claim 11, wherein said aqueous pigment dispersion has a total solids content of about 25 to 65 percent.

13. The method of claim 11, wherein said aqueous organic pigment dispersion further comprises one or more of the following: an extender, a rheological agent and an opacifying pigment.

14. The method of claim 11, wherein the amount of said aqueous pigment dispersion in said mixture is about 0.01 to about 8.00 weight percent of said vulcanized rubber particles.

15. The method of claim 11, wherein said step of mixing and adding occur sequentially.

16. The method of claim 11, wherein said emulsion polymer is selected from the group consisting of fully-saturated polyacrylate co/terpolymer, polyurethane, self-crosslinking functionalized polyacrylate multipolymer, styrene/butadiene rubber, and polybutadiene rubber.

17. The method of claim 15, wherein said emulsion polymer has a T_{g} in the range of about −70° C. to 20° C.

18. A method of converting vulcanized rubber into surface covering material comprising:
mixing rubber particles with an aqueous pigment dispersion to form mixture;
stirring said mixture to color coat said rubber particles thereby forming color coated rubber particles; and
adding an aqueous polymer dispersion to said color coated rubber particles to encapsulate said color coated rubber particles and form a protective film around said color coated rubber particles.

19. The method of claim 18, wherein said vulcanized rubber comprises scrap tires.

20. The method of claim 18, wherein said aqueous pigment dispersion comprises a pigment and an aqueous dispersant.
